(19) United States
(12) Patent Application Publication
(10) Pub. No.: US 2006/0162258 A1
(43) Pub. Date: Jul. 27, 2006

(54) Attachment structure for a weather strip

(76) Inventors: Takashi Yamashita, Hiroshima (JP); Takashi Ogawa, Saitama (JP)

Correspondence Address: SUGHRUE MION, PLLC, 2100 PENNSYLVANIA AVENUE, N.W., SUITE 800, WASHINGTON, DC, 20037, US

(21) Appl. No.: 10/526,889

(22) PCT Filed: Sep. 3, 2003
(86) PCT No.: PCT/JP03/11266

§ 371 Date: Mar. 4, 2005

(30) Foreign Application Priority Data
Sep. 5, 2002 (JP) P.2002-260477

(51) Int. Cl. E06B 7/16

(52) U.S. Cl. 49/495.1

(57) ABSTRACT

A structure of attaching a weather strip includes a roll sash of a sash door, and a weather strip attached to an outer circumferential end face of the roll sash, a hollow seal portion on the vehicle interior side and a seal lip portion on the vehicle exterior side of the weather strip formed integrated with each other into one body, the hollow seal portion and the seal lip portion coming into elastic contact with a vehicle body to seal a portion between the sash door and the vehicle body.

### TECHNICAL FIELD

The present invention relates to a structure of attaching a weather strip to a roll sash of a sash door of an automobile, whereby the weather strip is attached to the roll sash and comes into elastic contact with the automobile body so as to seal a portion between the sash door and the automobile body.

### BACKGROUND ART

Concerning the weather strip, which is attached to the roll sash 20 of the sash door 1 of an automobile, for sealing a portion between the roll sash 20 and the automobile body 14 when the weather strip comes into elastic contact with the automobile body 14, there is provided a weather strip shown in FIG. 3. FIG. 3 is a sectional view taken on line A-A in FIG. 1.

A structure of attaching the above conventional weather strip includes: a roll sash 20, on the vehicle interior side and the vehicle exterior side of which the recess portions 21, 22 are respectively formed being integrated with the roll sash 20 into one body; and a weather strip 24 in which the hollow seal portion 25 and the seal lip portion 26 are integrally formed. The base portion 27 of the hollow seal portion 25 of the weather strip 24 is fixed into the recess portion 21 on the vehicle interior side, and the base portion 28 on the seal lip portion 26 side is fixed into the recess portion 22 on the vehicle exterior side. In this way, the weather strip 24 is attached to the roll sash 20.

This structure of attaching the weather strip is advantageous in that the weather strip 24 can be strongly incorporated into the roll sash 20 because the weather strip 24 is attached via the two recess portions 21, 22.

However, in the conventional structure of attaching the weather strip, the following problems may be encountered. It is necessary to form the two recess portions 21, 22 in the roll sash 20. Accordingly, machining of the roll sash 20 is complicated.

The roll sash 20 is formed by the method of roll forming in which sheet metal is made to pass in a rolling machine a plurality of times. Therefore, in order to form the recess portions 21, 22, the profiles of which are complicated, having a plurality of protruding portions 23, a large number of man-hours are required.

Further, according to the conventional structure of attaching the weather strip, the base portion 27 of the hollow seal portion 25 of the weather strip 24 and the base portion 28 of the seal lip portion 26 must be respectively pushed into the recess portions 21, 22 so that they can be fixed into the recess portions 21, 22. Therefore, a large number of man-hours are required in the process of attaching work.

### DISCLOSURE OF INVENTION

It is an object of the present invention to provide a structure of attaching a weather strip characterized in that: a roll sash can be easily formed; and the weather strip can be easily attached to the roll sash.

In order to accomplish the above object, the present invention described in aspect 1 provides a structure of attaching a weather strip including: a roll sash (2) of a sash door (1); and a weather strip (5) attached to an outer circumferential end face of the roll sash (2), a hollow seal portion (6) on the vehicle interior side and a seal lip portion (8) on the vehicle exterior side of the weather strip being formed integrated with each other into one body, the hollow seal portion (6) and the seal lip portion (8) coming into elastic contact with a vehicle body (14) so as to seal a portion between the sash door (1) and the vehicle body (14), wherein one hook portion (3) is vertically arranged only on the vehicle exterior side of the roll sash (2), a protrusion (10) engaging with the hook portion (3) is formed in a base portion (9) of the seal lip portion (8) without forming a protruding portion on the vehicle interior side of the hook portion (3), and a base portion (7) of the hollow seal portion (6) is fixed to the roll sash (2) by a clip (15).

The present invention described in aspect 2 provides a structure of attaching a weather strip according to aspect 1, wherein the hook portion (3) is formed into a protrusion (4) directed downward by bending an upper end portion to the vehicle interior side and further by bending a forward end portion of the upper end portion downward, and the protrusion formed in the base portion (9) of the seal lip portion (8), which engages with the hook portion (3), is directed upward and formed into an upward protrusion (10).

In this connection, reference numerals in the parentheses represent corresponding components shown in the drawings and the embodiment of the present invention described later.

According to the present invention, the weather strip is attached to the roll sash in such a manner that the hook portion, which is arranged on the vehicle exterior side of the roll sash, for example, the protrusion directed downward, and the protrusion, which is arranged in the base portion of the seal lip, for example, the protrusion directed upward are engaged with each other, and no protruding portion is arranged in a portion from the hook portion to the vehicle interior side, and further the base portion of the hollow seal portion is fixed by the clip. Therefore, the roll sash can be easily formed and the weather strip can be easily attached to the roll sash.

As a means for attaching the weather strip to the roll sash, it is sufficient that only one hook portion is formed in the roll sash. In the conventional structure, it is necessary to form a plurality of complicated protruding and recessed portions such as protruding portions for holding the base portions of the weather strip. However, according to the present invention, it is sufficient that only one protruding portion is formed. Therefore, the roll sash can be easily formed by the method of roll forming.

In the case of attaching the weather strip to the roll sash of the present invention, the protrusion arranged in the base portion of the seal lip portion, for example, the protrusion directed upward is engaged with the hook portion of the roll sash, for example, the protrusion directed downward, and at the same time, the hollow seal portion is fixed by the clip. Therefore, it is unnecessary that the weather strip is fitted to the roll sash being pushed into two recess portions like the conventional structure. Therefore, the attaching work can be easily performed.

### BRIEF DESCRIPTION OF DRAWINGS

FIG. 1 is a side view showing an external appearance of an automobile provided with the structure of attaching a weather strip.

FIG. 2 is a view showing the structure of attaching the weather strip of an embodiment of the present invention. FIG. 2 is a sectional view taken on line A-A in FIG. 1.

FIG. 3 is a view showing the structure of attaching the weather strip of a conventional example. FIG. 3 is a sectional view taken on line A-A in FIG. 1.

### BEST MODE FOR CARRYING OUT THE INVENTION

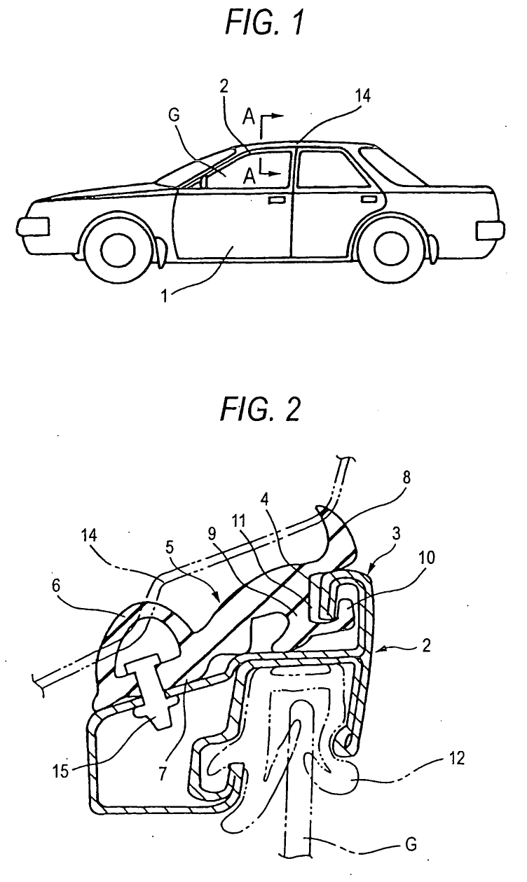

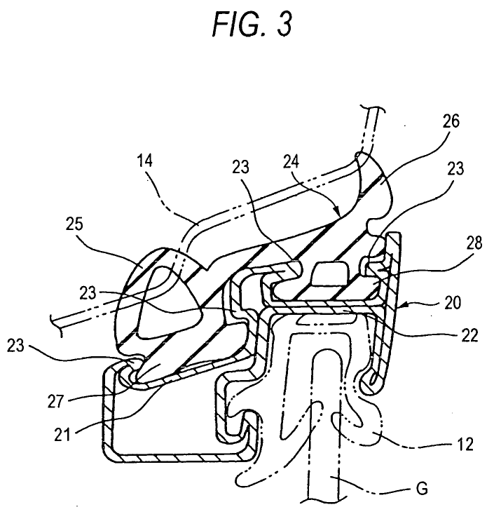

Referring to FIGS. 1 and 2, a structure of attaching a weather strip of the embodiment of the present invention will be explained below. FIG. 1 is a side view showing an external appearance of an automobile provided with the structure of attaching a weather strip, and FIG. 2 is a sectional view taken on line A-A in FIG. 1. Like reference characters are used to indicate like parts in the drawings of the conventional example and the embodiment of the present invention.

The structure of attaching the weather strip of the embodiment of the present invention includes: a roll sash 2 of the sash door 1; and a weather strip 5 attached to an upper end outer circumferential end face of the roll sash 2, in which the hollow seal portion 6 arranged on the vehicle interior side and the seal lip portion 8, the cross section of which is formed into a tongue-shape, arranged on the vehicle exterior side are integrally formed, wherein the hollow seal portion 6 and the seal lip portion 8 come into elastic contact with the vehicle body 14, so that a portion between the roll sash 2 and the vehicle body 14 can be sealed.

On the vehicle exterior side of the roll sash 2, there is provided only one hook portion 3 which is formed in the vertical direction in such a manner that an upper end portion is bent toward the interior side of the vehicle and further a forward end portion of the thus bent upper end portion is bent downward so as to form a protrusion 4 directed downward. In a portion from the position of the hook portion 3 to the vehicle interior side, no protrusion is formed for holding the base portion of the weather strip. Therefore, the upper end outer circumferential end face of the roll sash 2 is smooth except for the position where the hook portion 3 is arranged. In the base end portion 9 of the seal lip portion 8, there is provided a recess portion 11 into which the protrusion 4 is inserted. At the same time, the protrusion 10 directed upward to be engaged with the protrusion 4 directed downward is formed, and the protrusion 4 directed downward and the protrusion 10 directed upward are engaged with each other. Further, the base portion 7 of the hollow seal portion 6 is fixed to the roll sash 2 by the clip 15.

In this connection, the glass-run 12 coming into elastic contact with door glass G is attached to the lower face of the roll sash 2.

According to the structure of attaching a weather strip of this embodiment, it is sufficient that only the hook portion 3 is formed as a means for attaching the weather strip 5 to the roll sash 2. According to the conventional structure of attaching a weather strip, it is necessary that a plurality of complicated protruding and recessed portions for holding the base portions of the weather strip are formed. However, in the embodiment of the present invention, it is sufficient that only one hook portion is formed. Therefore, the forming of the roll sash 2 can be easily performed. Further, the weather strip 5 can be attached to the roll sash 2 in such a manner that the protrusion 10, which is directed upward, arranged in the base portion of the seal lip portion 8 is engaged with the protrusion 4 directed downward of the roll sash 2 and that the base portion 7 of the hollow seal portion 6 is fixed by the clip 15. Therefore, the weather strip 5 can be easily attached to the roll sash 2.

When the weather strip 5 is attached to the roll sash 2, the protrusion 4 directed downward of the roll sash 2 enters the recess portion 11 of the weather strip 5, and the protrusion 10 directed upward of the weather strip 5 enters the recess portion of the hook portion 3 of the roll sash 2. Therefore, in the same manner as that of the hollow seal portion 6, the seal lip portion 8 of the weather strip 5 can be stably and strongly attached to the roll sash 2.

In this connection, in the weather strip 5 of this embodiment of the present invention, the hollow seal portion 6 and the seal lip portion 8 are respectively arranged on the vehicle interior side and the vehicle exterior side considerably distant from each other. However, the present embodiment can be applied to a weather strip in which a portion of connecting the hollow seal portion 6 with the seal lip portion 8 is made short so that both can be arranged close to each other.

### INDUSTRIAL APPLICABILITY

As described above, the weather strip described in the present invention is attached to the roll sash in such a manner that the hook portion, which is arranged on the vehicle exterior side of the roll sash, for example, the protrusion directed downward, and the protrusion, which is arranged in the base portion of the seal lip, for example, the protrusion directed upward are engaged with each other, and further the base portion of the hollow seal portion is fixed by the clip. Therefore, the roll sash can be easily formed and the productivity can be enhanced. Further, the weather strip can be easily attached to the roll sash, and the attaching workability can be enhanced.

1. A structure of attaching a weather strip comprising:
a roll sash of a sash door; and
a weather strip attached to an outer circumferential end face of the roll sash, a hollow seal portion on the vehicle interior side and a seal lip portion on the vehicle exterior side of the weather strip being formed integrated with each other into one body, the hollow seal portion and the seal lip portion coming into elastic contact with a vehicle body so as to seal a portion between the sash door and the vehicle body, wherein
one hook portion is vertically arranged only on the vehicle exterior side of the roll sash,
a protrusion engaging with the hook portion is formed in a base portion of the seal lip portion without forming a protruding portion on the vehicle interior side of the hook portion, and
a base portion of the hollow seal portion is fixed to the roll sash by a clip.

2. The structure of attaching a weather strip according to claim 1, wherein
the hook portion is formed into a protrusion directed downward by bending an upper end portion to the vehicle interior side and further by bending a forward end portion of the upper end portion downward, and
the protrusion formed in the base portion of the seal lip portion, which engages with the hook portion, is directed upward and formed into an upward protrusion.
